(19) United States
(12) Patent Application Publication
(10) Pub. No.: US 2008/0018091 A1
(43) Pub. Date: Jan. 24, 2008

(54) Photo Album

(76) Inventors: Yu Kyung Hwang, Seoul (KR); Eui Kwon Hwang, Seoul (KR)

Correspondence Address: DICKSTEIN SHAPIRO LLP, 1825 EYE STREET NW, Washington, DC, 20006-5403, US

(21) Appl. No.: 11/629,878

(22) PCT Filed: Jun. 8, 2005
(86) PCT No.: PCT/KR05/01716

§ 371 Date: Dec. 18, 2006

(30) Foreign Application Priority Data
Jun. 19, 2004 (KR) 20-2004-0017354

(51) Int. Cl. B42D 5/00; B42D 17/00

(52) U.S. Cl. 281/38; 281/45

(57) ABSTRACT

An album pasteboard structure includes a pair of first surfaces onto which photographs are attached, a pair of second surfaces that correspond to the pair of first surfaces so as to be attached to the first surfaces, and a base plate that includes a partition formed at the center; an adhesive layer that is applied over the entire surface of the first surfaces except for the separation; and a release paper that is as thick as the partition of when the base plate is folded along the partition before the photographs are mounted, and that is attached to the first surfaces such that the release paper can be removed from the adhesive layer.

### TECHNICAL FIELD

The present invention relates to photo albums.

### BACKGROUND ART

Generally, photos, taken by a conventional camera, can be inserted into vinyl pockets of slip-in albums or be displayed on the self-adhesive album pages coated with removable pressure-sensitive adhesive and attached with transparent film on both sides. Multiple photos can be displayed in conventional photograph albums but cannot be displayed together with the background design of a user's personal taste and with descriptions of the photos. There are other methods of storing multiple photos, such as, printing them into a memorial book at a printing shop. However, no shop will print just one book or two rather than in bulks. Also, in such a case, the high cost would be a problem. Therefore, it has a disadvantage in that substantial amount of money must be invested in order to make a wedding photo book, 60^{th} birthday anniversary photo book, children's photo scrap book showing growing up photos from infancy to adulthood and other photo books.

Recently, more photos are taken by digital cameras and can now be easily edited on computers into various sizes and shapes with background designs of a user's personal taste and also with descriptions of the photos. The photos edited with background designs and with descriptions can be printed onto an A4 (210×297 mm) size paper and also on other sized papers to be attached and compiled onto album pages coated with removable pressure-sensitive adhesive. This can be a storage method for photos or can be used as personal photo storybooks.

FIG. 1 is a partial perspective view of pages of a conventional album in which the digital photos are attached and stored; and FIG. 2 is a cross-sectional view of the pages in a conventional album of FIG. 1 showing the stacked structure thereof in the absence of attached photos. As illustrated, the pages of the album, attached to and stacked onto the base board (2), comprises the base pages (4) coated with removable pressure-sensitive adhesives (6) on both sides, silicone-coated release papers (8) attached to the adhesive (6) and spacers (10) that represent the difference in thickness of photos and release papers that are inserted between the release papers (8) in order to prevent the gap that could be created by the difference after the album gets bound.

In a conventional album structured as stated above, the release papers (8) are removed after the removal of spacers (10), and photos (P) that are designed and edited on computers according to personal preferences and printed on ordinary printing papers (on inkjet print paper or on other photo paper) are attached to the removable pressure-sensitive adhesive (6)-coated base page (4) for storing the photos. FIG. 3 is a cross-sectional view showing laminated structure of the pages with the attached photos (P).

### DISCLOSURE

### Technical Problem

Known conventional albums have disadvantages. In conventional albums, to prevent the base pages from sticking to each other, silicone coated release papers have to be attached to the base pages and spacers have to be inserted between the release papers. The manufacturing process for inserting the spacers and the silicone coated release papers is complicated and the manufacture costs a lot.

### Technical Solution

An objective of the present invention is therefore, to provide a photo album that has a simple structure without a need for an insertion of spacers thereby it can be easily manufactured.

In a preferred embodiment, a photo album with photo-mounting pages adhered to a base board, the page includes a base page, a removable pressure-sensitive adhesive layer formed at both surfaces of the base page, and a non-woven fabric, which is attached to the removable pressure-sensitive adhesive layer for modulating the gap between the pages and serves as a release paper.

The adhesive layer is formed with micro-sphere adhesives. Unlike a layer made of regular adhesives, the layer made of a micro-sphere adhesive does not need to be subjected to a separate treatment facilitates the release of the attached photos.

### Advantages Effects

The photo album of the present invention comprises base pages, removable pressure-sensitive adhesive layer formed with micro-sphere adhesives, and album pages consisting of removable non-woven fabrics functioning as a release paper and also as a spacer that moderates the gap between base pages. Therefore, the album does not need to be provided with a separate spacer and the manufacturing of this album becomes easier through a simplified construction.

### DESCRIPTION OF DRAWINGS

FIG. 1 is a partial perspective view of pages of a conventional album.

FIG. 2 is a cross-sectional view of the pages of a conventional album showing the stacked structure thereof in the absence of attached photos.

FIG. 3 is a cross-sectional view of the pages of a conventional album with attached photos.

FIG. 4 is a partial perspective view of the pages in the photo album of the present invention.

FIG. 5 is a cross-sectional view of the pages in the photo album of the present invention in the absence of attached photos.

FIG. 6 is a perspective view of the photo album with the application of the present invention.

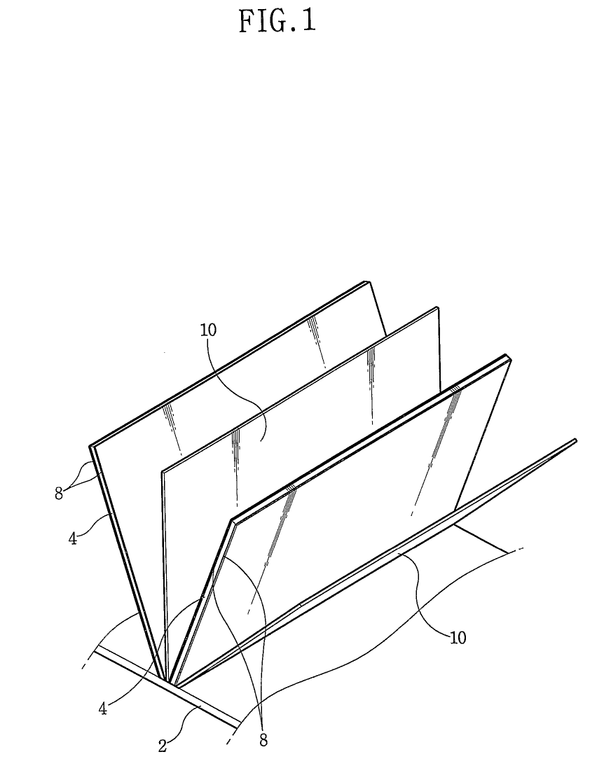

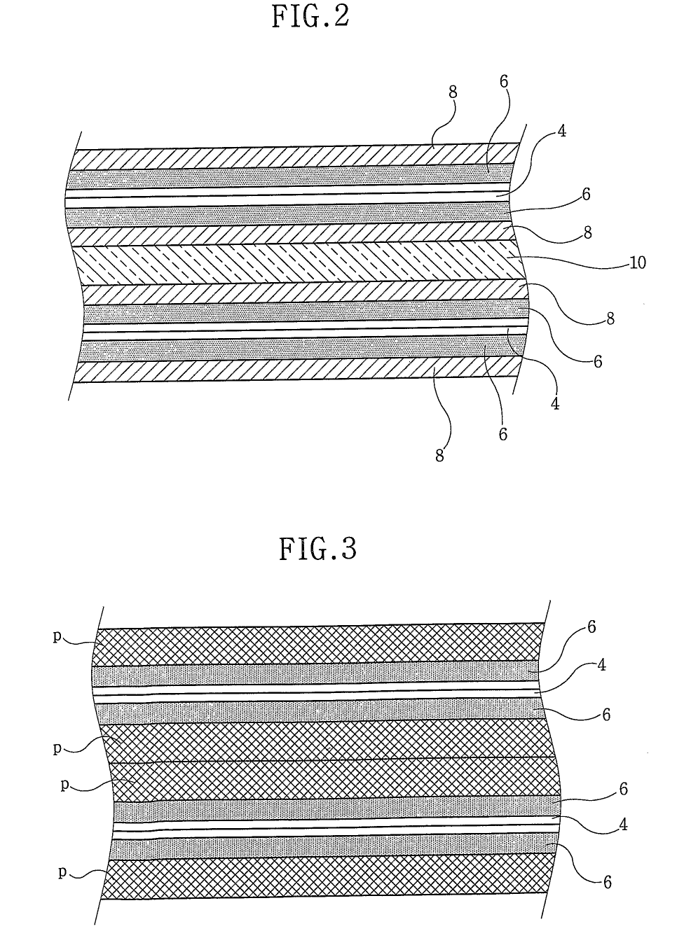

Description of Reference Numerals for Main Parts of the Drawings

| | | |
|---|---|---|
| 12: | base board | 14: base page |
| 16: | removable micro-sphere | 18: non-woven fabric |
| | pressure-sensitive adhesive | |

### MODE FOR INVENTION

The present invention is described in detail below in reference to the attached figures.

In the present invention, not only digital print photos but also conventional wedding photos, baby photos or other event photos that are processed in the size of the album or in a slightly smaller size than that of the album can be attached to the album of the present invention. The following will be described by way of using the example of digital print photos.

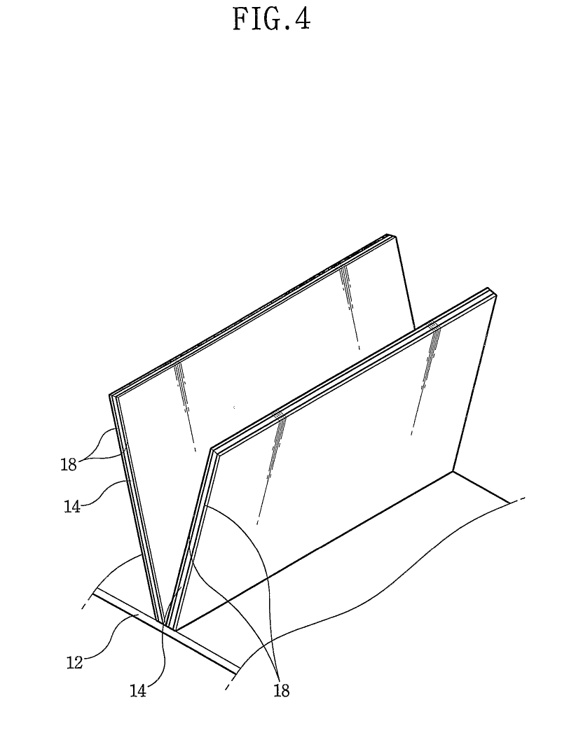

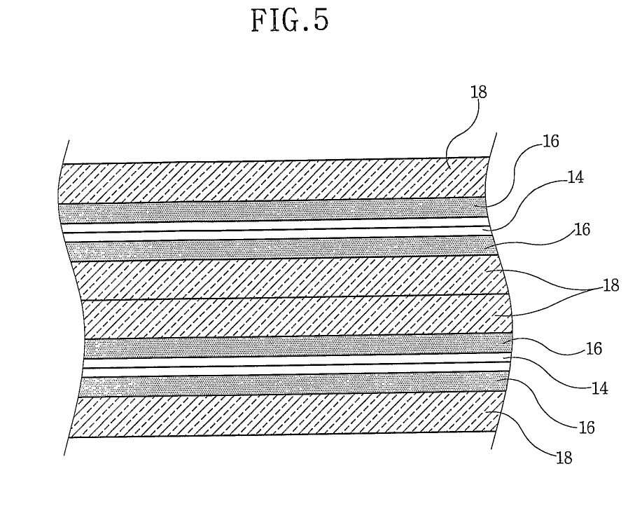

FIG. 4 is a partial perspective view of the photo album of the present invention that stores digital print photos by attaching them thereto. FIG. 5 is a cross-sectional view of the pages in FIG. 4 of the present invention in the absence of attached photos. As illustrated in the drawings, the album page attached to the base board (12) comprises a removable pressure-sensitive adhesive layer (16) coated with adhesives over both sides of base pages (14), a non-woven fabric (18) attached to the movable pressure-sensitive adhesive layer (16) and functioning as release papers and as spacers moderating gaps between album pages.

The removable pressure-sensitive adhesive layer (16) formed with micro-sphere adhesives does not need to be subjected to a separate treatment that facilitates release of the attached photos, whereas the adhesive layer made of conventional adhesives needs to be subjected to such treatment.

The density of a non-woven fabric (18) is lower than that of ordinary paper. The weight volume ratio works in favor of non-woven fabric as its higher volume ratio functions effectively as spacers between the base pages (14).

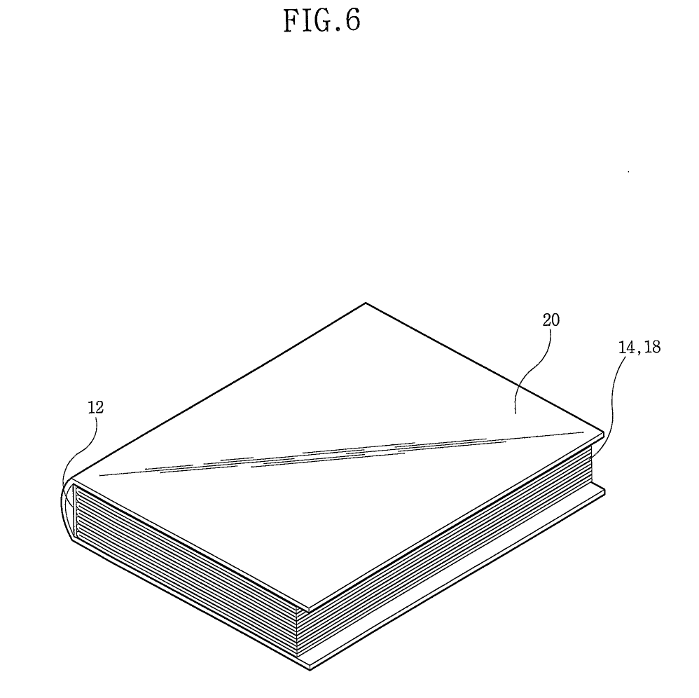

In the photo album of the present invention, the non-woven fabrics (18) are removed, and photos edited with background designs and with descriptions using a computer are attached to the movable pressure-sensitive adhesive layer (16) for storing the photos. The laminated structure of page after the non-woven fabrics (18) is substituted by photos shown in FIG. 5. FIG. 6 depicts a digital photo album according to the present invention after the album pages are bound with covers (20) and a base board (12).

1. A photo album with photo-mounting pages adhered to a base board, said page comprising:
a base page;
a removable pressure-sensitive adhesive layer formed at both surfaces of said base page; and
a non-woven fabric, which is attached to said removable pressure-sensitive adhesive layer for modulating the gap between said pages and serves as a release paper.
